(19) United States
(12) Patent Application Publication
(10) Pub. No.: US 2018/0018636 A1
(43) Pub. Date: Jan. 18, 2018

(54) SOCIALLY INFLUENCED COLLABORATION TOOLS

(71) Applicant: International Business Machines Corporation, Armonk, NY (US)

(72) Inventors: Jeffrey E. Bisti, New Paltz, NY (US); Jovanna Marquez, Longwood, FL (US); Alyssa N. Recinella, Queensbury, NY (US)

(21) Appl. No.: 15/357,060

(22) Filed: Nov. 21, 2016

Related U.S. Application Data
(63) Continuation of application No. 15/209,248, filed on Jul. 13, 2016.

(51) Int. Cl. G06Q 10/10; H04L 29/06

(52) U.S. Cl. CPC G06Q 10/1095; H04L 65/403; G06Q 10/103; H04L 65/4015

(57) ABSTRACT

A system and method for recognizing a team of collaborators (individuals) who meets regularly, and automatically providing appropriate documents and resources to the collaborators for greater efficiency. The system and method identifies collaborative groups who meet on regular basis and dynamically formed groups/teams. Inputs are received to the system from various systems and non-deterministic analysis techniques are employed for building, identifying, and/or learning patterns of collaboration among individuals who meet together on a repeating basis. Data inputs are obtained based on meeting logistics through scheduling tools, emails, call-in numbers, web conference reservations, and the input of facilities, e.g., badge readers, telephone conferences. Patterns may be learned/established through recognition of inputs and comparisons to already-collaborating groups. The system further identifies resources that are already being used and shared between the individuals of the group so that the next time that meeting happens, the resources are readily available for the individuals.

### FIELD

The present disclosure relates to the collaboration tools, particularly to a resource-recall system and method for socially influenced collaboration tools.

### BACKGROUND

In a collaborative workplace that makes use of digital resources, getting all of these assets and resources together for meetings (e.g., in-person or on-line) can often take up a non-trivial portion of a meeting's allotted time. It is not uncommon for one person to find themselves the sole owner of a resource that is key to the group's collaboration, possibly a document that the group is working on, a list of URIs that a front-end developer is using, or a note that was not sent out to the full group. Even if the resource is openly available to everyone, it can often be the case that they're the only ones who know where to find it. This highlights the gap between having access to resources and having it readily available.

Collaborative workplace tools, such as wikis, document sharing services, and communities, help collaborators share resources, and make it possible to have these resources available, virtually, but this often still requires manual setup and intervention.

For example, a particularly busy person may have a calendar that is 8 hours of back-to-back meetings, with no time to prepare from one meeting to the next, and no overlap in terms of context or shared resources from their 2:30 to their 3:00 appointments. They may be so busy with meetings that they do not have time to handle the administrative tasks associated with their meetings.

It is also becoming commonplace where the requirements of a meeting may shift from one instance to the next. A group consisting of 12 people at its fullest, may only meet as a full group once per month, but break out into sub-groups throughout the week. For example, one sub-group may focus on technology, another on messaging, and another on tracking defects. They all need access to the same overall corpus of data, but have a different set of priorities, and will have different styles of collaboration. Having resources such as call-in phone numbers, passwords, and presentation files controlled by, and ultimately linked to people can hinder these types of collaborations.

### SUMMARY

A computer-implemented resource-recall system under a collaborative environment for regularly occurring meetings. The computer-implemented system provides a collaboration tool configured to automatically recognize when a team of users or collaborators meets regularly and provide the appropriate documents and resources automatically to ensure a smooth meeting. The collaborative system automatically grants access to regularly used documents, on-line resources and/or web-links during a regularly scheduled meeting to all applicable parties.

The system detects dynamic groups, e.g., by use of calendar integration. The approach being purely based on meeting logistics and the inputs of facilities (e.g., badge readers, telephone conferences, etc).

According to a first aspect, there is provided a method to provide resources to a group of collaborators. The method comprises: receiving, at a processor, data representing events associated with individuals at a particular time and location; tracking by the processor, repeated instances of events involving the individuals; tracking by the processor resources accessed by or shared with the individuals in association with one or more the repeated tracked events involving the individuals; determining, by the processor, a group collaboration of the individuals based on the event tracking and resource sharing, receiving data indicating a subsequent event planned for the one or more the group of individuals; and at the subsequent event involving one or more the group of individuals, automatically providing or enabling access to resources for members of the identified collaborative group based on the tracked resources.

In a further aspect, there is provided a resource-recall system under a collaborative environment. The system comprises: a memory storage device; a processor unit in communication with the memory storage device and configured to receive data representing events associated with individuals at a particular time and location; track repeated instances of events involving the individuals; track resources accessed by or shared with the individuals in association with one or more the repeated tracked events involving the individuals; determine a group collaboration of the individuals based on the event tracking and resource sharing, receive data indicating a subsequent event planned for the one or more the group of individuals; and at the subsequent event involving one or more the group of individuals, automatically providing or enabling access to resources for members of the identified collaborative group based on the tracked resources.

In a further aspect, there is provided a computer program product for performing operations. The computer program product includes a storage medium readable by a processing circuit and storing instructions run by the processing circuit for running a method. The method is the same as listed above.

### BRIEF DESCRIPTION OF THE SEVERAL VIEWS OF THE DRAWINGS

Embodiments are described in more detail in conjunction with the accompanying drawings, in which:

FIG. 1 diagrammatically depicts a system for socially enhanced collaboration tools in one embodiment;

FIG. 2 conceptually shows a decision engine logic receiving influencing signals or events in one embodiment, resulting in the determining of multi-user collaborators and providing resources for their collaboration;

FIGS. 3A and 3B depict a methodology for socially enhanced collaboration tools in one embodiment; and

FIG. 4 illustrates a schematic of an example computer or processing system that may implement the resource-recall system and method in the embodiments of the present disclosure.

### DETAILED DESCRIPTION

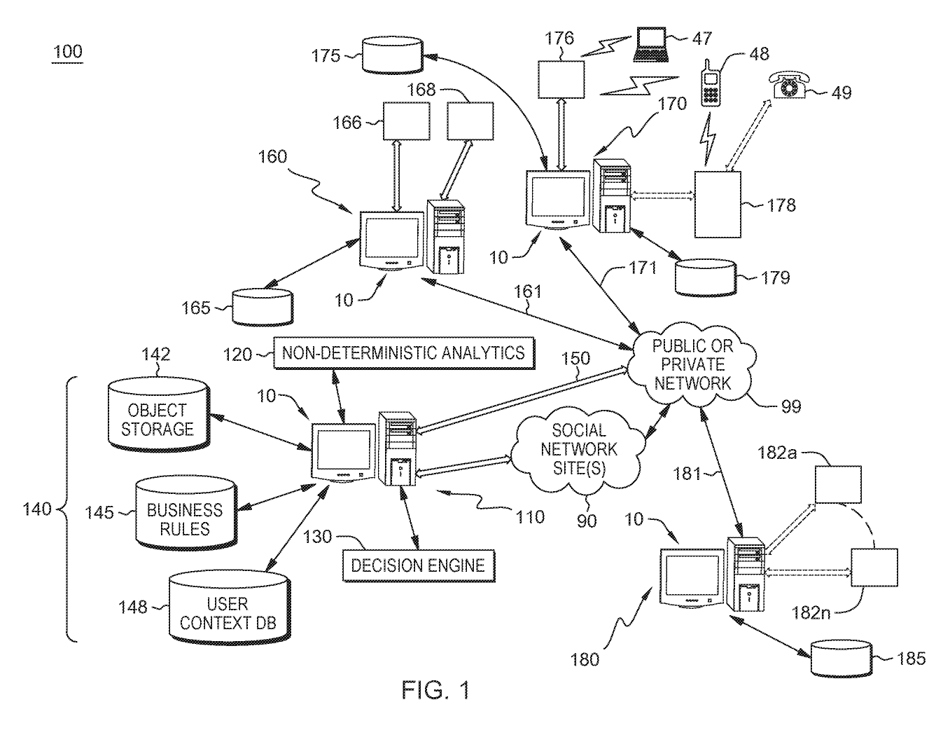

With reference now to FIG. 1, there is provided a system 100 and methodology for socially enhanced collaboration tools. The system 100 for socially enhanced collaboration tools is embodied as one or more computer systems implementing methods to automatically make available to people who meet together on a repeating basis their frequently accessed resources when those people are most likely to need them. As a non-limiting example, a collaborating group of users meeting with their “defect review” team will automatically have access to source code, developer contacts, and defect reports without having to go searching each time the users meet.

In one embodiment of the system 100, collaborative groups of users are not statically defined, but rather dynamically learned through a number of inputs, including but not limited to: scheduling software, social media input, sensory input sources, e.g., personnel sensors, RFID badges, and others. The more inputs the system has, the more accurate its predictions of collaborating groups will become.

Once collaboration has been established through use of a learning algorithm, the system provides access to and makes readily available any commonly-accessed tools, resources, files and digital assets to the participants. In a non-limiting example, if four people (e.g., Bob, Betty, Mary, and Mike) regularly get together in a location (e.g., a Suite 455) to work on a project (e.g., Performance Metrics), the system will pick up on that pattern. That is, in one embodiment, a small set of information is used to build a pattern for future use. Once the pattern is detected, the system will automatically provide enhancements and resources to: 1) Make readily available the applications and documents that were open the last time this meeting was held; 2) Create/Join an online/telephone collaboration for regular attendees; and 3) Provide a template for meeting minutes which includes a list of the attendees and date/time, as this is often a long, multi-step process.

In an alternative embodiment, this automated ability to provide enhancements and resources could be manifested in populating a browser's bookmarks area, populating an area of a user's mobile device with relevant apps, or programming a room's conference room phone with the dial-in information for a meeting.

In example embodiment, the use of input data to build a pattern may implement predictive modeling techniques. For example, Google® includes an application for taking text and context clues from e-mails and conversations to build events in the user's calendar.

As shown in FIG. 1, system 100 is a computing system provided with resource-recall collaboration tool 110 configured for use in a business or enterprise to facilitate communication and collaboration among a group(s) of users. The tool 110 may be embodied as a computing system 10 having at least the components as shown in FIG. 5. In one embodiment, the collaboration tool 110 implements non-deterministic analytics methods 120, for detecting patterns of user collaborations based on a variety of social and sensory inputs. The collaboration tool 110 implements decision engine logic module 130 including a learning algorithm for detecting patterns and deciding whether and how to enhance the collaboration effort for the next anticipated user collaboration.

In the embodiment shown in FIG. 1, computing system tool 110 receives inputs via communications link 150 in the form signals communicated over a communications network 99, e.g., a private LAN, WAN, or a public network, from a variety of distributed sources. These signals received from various sources via communications link 150 include one or more “influencing” signal inputs or events 161, 171 and 181 that may be analyzed in conjunction with each other to detect collaboration patterns among users and determine whether and provide enhancements for the next and subsequent collaboration amongst those users.

In one embodiment, influencing signal inputs or events 161 for receipt at system 110 via communications link 150 may sourced from security installations at site facilities 160 associated with the enterprise or business entity. Such a security installation at a site facility may communicate data and information signals 161 indicating badge accesses of certain individuals, for example, at a particular time and/or location, e.g., a building or room. Such a security installation 160 may implement badge readers 166 or other proximity (RFID) sensors 168 configured to either communicate the data information signals 161 directly to the system 110 or communicate over the communications network 99. For example, some of these systems might include security/facility management software (e.g., ZoneMinder™ software). Such badge or sensor access data may be additionally stored for later use in a database 165.

Another influencing input received at system 110 may include teleconferencing and web-conferencing signals 171 identifying users such as may be obtained from conferencing schedules or as associated with real-time video/audio signals communicated over a network 99 from a teleconferencing service 176 or an internal messaging and conferencing system/service 178. Further embodiments include inputs identifying users of an on-line “chat” room. Such a teleconferencing system 176 or internal messaging/conferencing system 178 are configured to enable plural users to communicate with each other via mobile devices, e.g., mobile phones, smart phones, laptop computers 47, tablets, personal digital devices 48, telephones 49, etc. These systems 176, 178 are further configured to either communicate the data information signals 171 directly to the system 110 or communicate over the communications network 99. Such information relating to use of teleconferencing services 176 and internal messaging/conferencing system 178 may be additionally stored for later use in respective databases 175, 179.

A further input received at system 110 may include influencing signals 181 carrying message data and or message metadata and/or other signals communicated over a network 99 such as from an internal messaging and conferencing system 180 or inputs from network access points indicating users accessing certain applications or web links as may be provided by accessing network access logs. For example, activity at wireless network access points 182a, . . . , 182n may be logged in computing device 10 and configured to either communicate this information as signals 181 directly to the system 110 or communicate over the communications network 99. In an example embodiment, Wi-Fi access points may be accessed for tying user IDs to access points located throughout a facility, e.g., to inform who is gathered in a particular area. Such network access point usage information at system 180 may be additionally stored for later use in a database 185. Rather than sorting through logs directly, in one embodiment, this influencing information may be further made available through higher-level queries, which are surfaced via APIs or web interfaces.

Further inputs to system 110 may include data accessed from an on-line scheduling service or application, information from entries of a file sharing log or database records (not shown). Such systems may make use of scheduling software provided by for collaboration such as Google® Calendar. Further inputs may include data from social media web-site 90, of FIG. 1 for use in determining collaboration.

In one embodiment, the system may periodically receive the information from the various influencing systems or receive input “events” in real-time, e.g., RFID badge information from signals 161 received from system 160 in real-time as a group is gathering at a particular office, room or conference, or detect in real-time whether a teleconference (video and/or audio) involving several users has been initiated with signals 171 received from system 170.

In one embodiment, the systems that provide respective event input to the system 110 for socially influenced collaboration can be independently operating, but provide application programming interfaces (APIs) for connectivity. In this way, developers can write software that make use of, and extend, the functionality provided without having to screen-scrape or use proprietary software. An example of extending functionality through API could be the access that is given to the Nest™ home automation appliances. Just as a user can access much of the device's functionality through the built-in interface, the user can also use features of the device through an API access (e.g., see for example: https://developers.nest.com/documentation/api-reference.

In one embodiment, the system 110 may be configured to enable users to query the various systems 160, 170, 180, etc. for particular information. In one embodiment, users may query various systems through any number of interfaces or methods mentioned before, including APIs, web interfaces, and direct database and log access.

In one embodiment, the system 110 may receive the event data and information over a communications network 99 such as a local private network or a public network. Decision engine 150 implemented at computer system 110 implement methods for building and detecting collaboration patterns based on the influencing inputs that the system learns. Further, based on the inputs, engine 150 implements logic to determine particular patterns of collaboration, e.g., amongst plural users of a group, and further determine the identities of the actual users anticipated to be part of the next group.

The decision engine logic further automatically determines possible resources for use by a particular collaborating group or individual user of that group at a next anticipated collaboration or meeting. For example, based on detecting a scheduled on-line conference among a group of users, a reminder notification may be provided to the users about the availability of a particular resource required for the meeting. For example, a communication in the form of a reminder pop-up may be provided to the participating user's device with a link to a particular resource, e.g., a shared file location, required for the scheduled meeting.

In one embodiment, decision engine employs results obtained from non-deterministic analysis block 140 that is then run on system 110 to receive and process the input influencing inputs to perform analysis. The analysis may invoke particular algorithms that detect patterns of collaborations of users and identify the users of a group or collaboration based on the influencing inputs.

Implementing decision engine 150, collaborative groups will not be statically defined, but rather dynamically learned through one or more of the influencing inputs, e.g., scheduling software, social media input, sensory input sources, e.g., personnel sensors, RFID badges, and others.

The more inputs the tool receives, the more accurate its predictions will become. For example, in one embodiment, using non-deterministic analytics, events or like influencing signal inputs are analyzed for the likeliness of them being related to any other events. The system tool 110 may thus detect a series of possibilities that can be used in concert with other information to make a best guess at what resources will be helpful for that meeting/event.

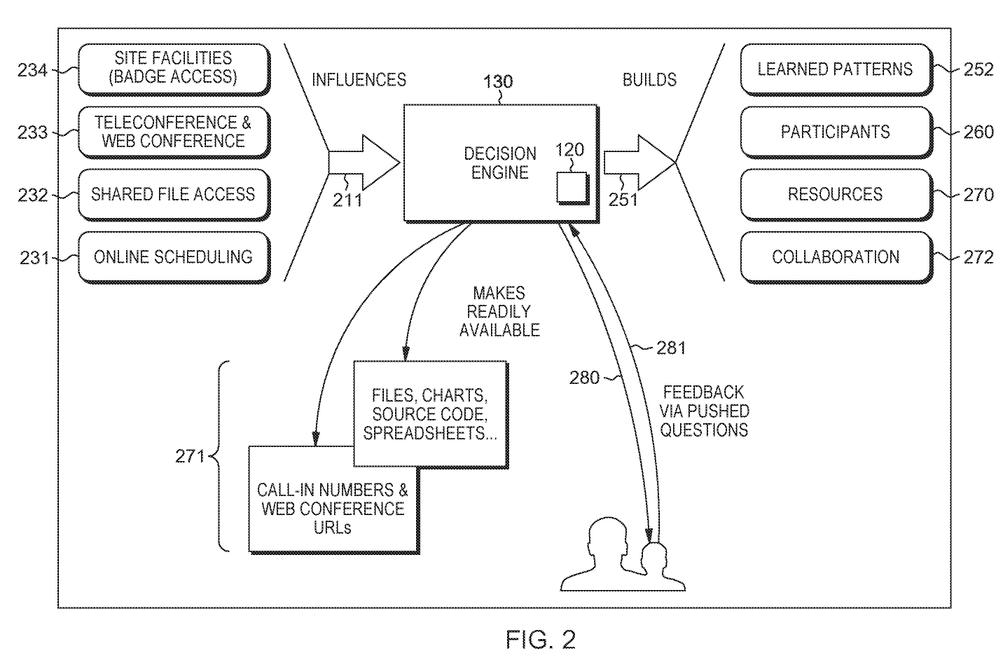

FIG. 2 conceptually shows the logic employed at the decision engine 130 run at the computer system implementing tool 110 that includes receiving influencing signals or events data 211 resulting in the build 251 and detecting of learned patterns 252 of collaboration among individuals 260, and determining of resources 270 for use in an anticipated subsequent collaboration 272.

In the embodiment depicted, the influencing inputs such as data inputs received from online scheduling systems 231, identified shared file access locations 232, teleconferencing and web conferencing systems/services 233, and RFID or like badge readers 234 are processed by the decision engine 130 including running non-deterministic analysis techniques 120 invoking algorithms to learn, track and detect patterns 251 of collaboration of individuals, identifying the participants 260 of the collaboration, tracking and optionally storing the resources 270 used at the detected collaborative meetings, identifying a next collaboration based on the detected patterns, and determining the resources based on the patterns to provide to the participants.

In one embodiment, the logic implemented at decision engine may further initiate communication to and query participants of a particular group or collaborating individuals, such as administering or automatically pushing to such individuals and/or their associated devices a questionnaire 280. An additional source of input for the decision engine 130 may then include feedback such as the responses to the questions posed to participants. These questions will emerge when a deviation from the expected or established pattern. For example, if a tracked meeting typically has four people, and the same four have been meeting this way for several weeks, but in the fifth week, a fifth person enters the collaboration room along with everyone else. This additional person could be someone who is new to the team, or someone who is non-essential and is just there for another reason. That fifth person badging into the room could be one clue that the group has changed. That fifth person accessing files typically associated with that group could be an additional clue to the system that a change should happen. To confirm this, the system 110 implements methods for providing simple questions which can be replied to with minimal distraction to provide answer/information feedback 281 into the decision engine 130.

In one embodiment, a user benefits from this system without needing to enter any information or sign up for any services; rather the system and method automates the administrative tasks associated with collaboration. Their workplace's existing systems for administrating schedules, resources, and facilities serve as a source of information which can be used to make informed decisions about what types of collaboration is happening. This also allows for informal, unscheduled meetings to benefit from the system just as much as scheduled, repeating meetings.

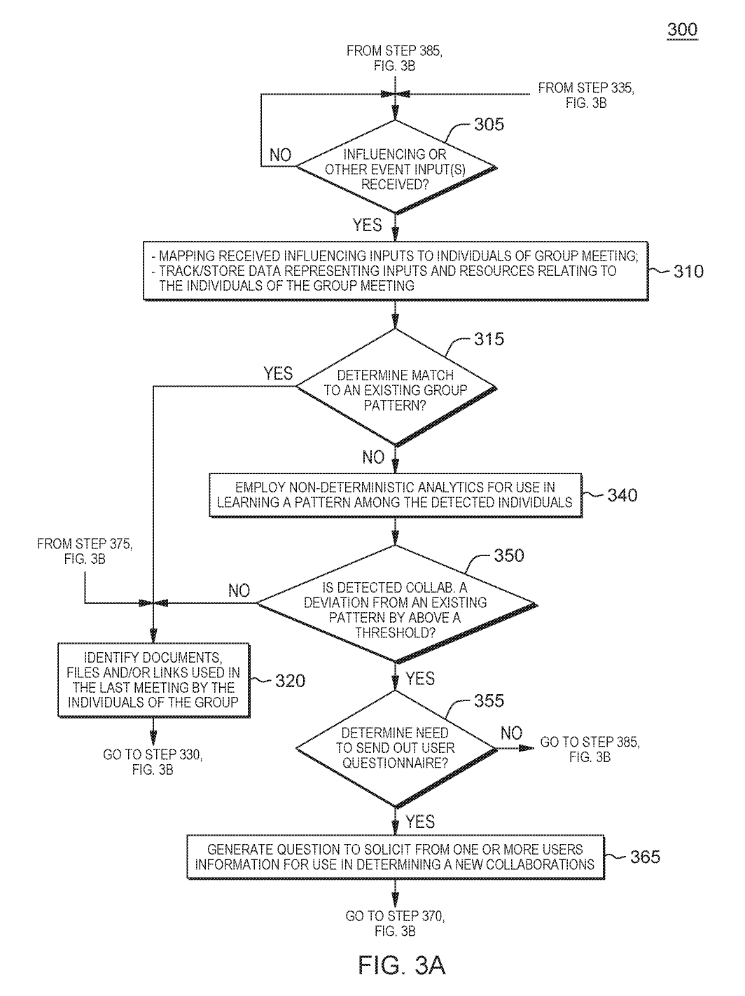

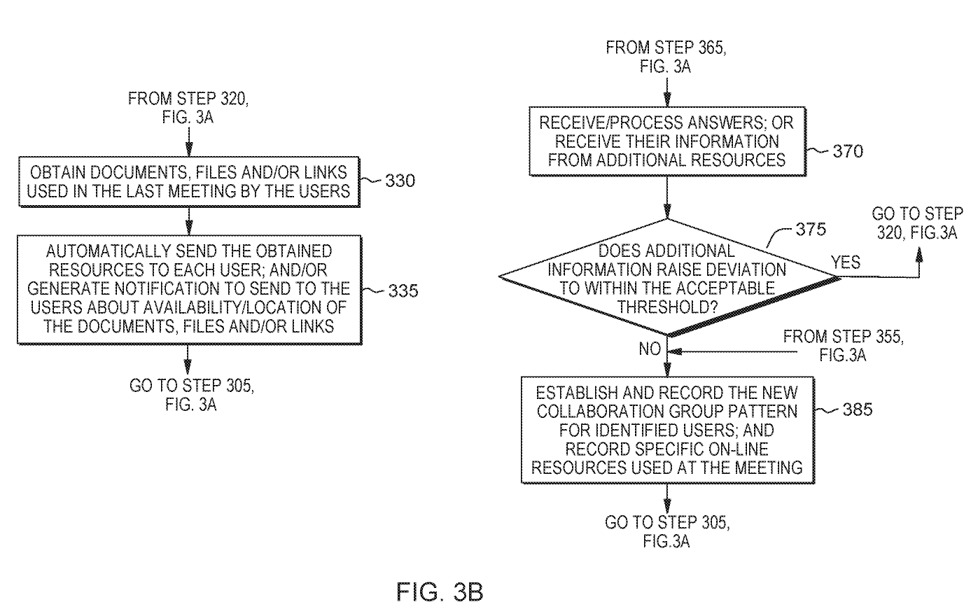

FIG. 3 depicts one embodiment of a methodology 300 implemented at the decision engine 130 and performed by the computing system 110 of FIG. 1. In a first step 305, the decision logic engine determines whether it has received a notification of event inputs which are influencing. In one embodiment, this may be in an on-line context as events happen in real time, or otherwise at 305 the decision engine may be granted access to the resources off-line for processing (i.e., the system may cache data so it can be referenced without calling back to the original system. These inputs may include any of the inputs described herein that may be received from one or more of the various systems 160, 170 and 180 and which may include scheduling information regarding collaborating users such as available form a scheduler or collaboration software or tools such as wikis, document sharing services, and communities, and tools that help collaborators share resources, a social media input (such as sourced from social media network/web-site 90, and/or sensory inputs information obtained from personnel sensors, e.g., RFID badges, that collaborating users have gathered or are to be gathered at a particular time/location.

Then, at step 310, from the received influencing inputs, the decision engine logic identifies the individuals associated with the received inputs or scheduled events. In one embodiment, the method maps received influencing inputs to a known group of individuals the system has already identified as group, e.g., based on a detected pattern, or to a “to be determined” group of individuals. Optionally, or in addition, this would include tracking and storing data representing the received inputs and resources used by the individuals of the group meeting. Data recorded and stored for tracking purposes may include the received influencing inputs data, e.g., identifiers of the individuals, the type of received inputs, the time, and location from where the received inputs originated. Additionally tracked and stored are any the resources used by any of the individuals, e.g. files accessed, web pages accessed, etc. are recorded and stored for tracking purposes.

Continuing at 315, the decision engine logic determines whether the received data indicates or is associated with an established or recurring (e.g., scheduled) collaboration group or conforms to an existing collaborative pattern involving a sub-set or all of those identified individuals. The use of predictive models for data may lead to the pattern detection.

If, at 315, it is determined that the received event data is associated with a recurring or upcoming scheduled event, or an exact match exists between the current received influencing event data for those identified individuals and an existing collaborative group pattern, i.e., then the process proceeds to step 320.

In one embodiment, decision engine logic may map (e.g., using a look-up table) the received influencing inputs to the associated individuals and from those individuals to determine if these influencing inputs are associated with an existing pattern of a group or collaborating entity involving those individuals, e.g., whether its is associated with an established/scheduled recurring event or ad-hoc assembled. An example of an exact identification would be if a meeting notice was sent out, four (4) people accepted, and those four people showed up. In this situation, the need for predictive modeling and context clues would be very low, as the exact details of the meeting have been included in the creation of the meeting entry in the calendar scheduling system.

Upon detecting by the decision engine logic a scheduled or non-scheduled meeting among individuals that matches an existing pattern or if the current received influencing event data matches an existing pattern of an established and/or recurring collaboration, then the process proceeds to 320 in which the decision engine invokes methods to determine whether any resources, e.g., documents, files and/or network locations (links), were used or accessed by the group individuals or collaborators in their last or immediately prior meeting. Assuming such resources were used or accessed by one or more individuals of the group, the method proceeds to step 330, FIG. 3B, to obtain those resources, e.g., documents, files and/or on-line network locations or links thereto used during the last meeting of that group of individuals.

Further, at 335, FIG. 3B the system automatically sends the obtained resources to each user; or generates notification to send to each of the users of the group. In one embodiment, the system automatically communicates or sends the obtained resources to each user; and/or generate a notification to send to each of the attending group users via their designated user devices, e.g., cell phone, e-mail calendar, about availability/location of the documents, files and/or links as determined based on the tracked resources associated with the detected pattern. In this instance, existing collaboration or scheduling system software may be consulted to determine the context and resources of the prior meeting of the matched group of collaborating users.

Alternatively, or in addition, the system may automatically provide the individuals at the group meeting, users with direct access to the documents, files and/or links via their designated devices at the time of or before the current or next meeting. For example, a notification may be generated and received by a user in the form of a pop-upon-screen notification with a link, for example, displayed via one or more of the user's designated device(s).

In one implementation, there may be an additional menu similar to “recent items” that would have a “relevant items” displayed via a user display interface for PC applications. Or on mobile devices, a mechanism similar to iBeacon that may cause a particular application to show up at the bottom of an iPhone® screen, making it easier to launch relevant apps. There may also be pre-programmed a conference room telephone with the call-in information for the meeting, making it easier to dial in. This permits individuals to walk into the meeting with less preparation time involved.

Upon communicating or sending the notification and/or actual resources to each identified user at 335, the method returns to step 305, FIG. 3A in order to repeat the resource provisioning method 300 for detected collaborators.

Returning back to 315, FIG. 3A, if decision engine logic determines no match exists between the current received influencing event data and individuals of an existing pattern of an established or recurring collaboration, then the process will proceed to 340 in which decision engine logic may employ non-deterministic analytics 120 for use in detecting a pattern among the identified users. In one embodiment, the system attempts to associate the meeting that is happening with existing established meetings (e.g., “this is the same collection of people from yesterday, getting together in the same room, so it's probably a continuation of that meeting.” This may involve determining the need obtain and/or consulting additional resources for additional information in helping to discern or establish a pattern of collaborating users.

In one embodiment, each of the received inputs that are stored and tracked is accessed for use by analytics processing technique to learn a pattern based on the tracked inputs. The decision engine logic may employ non-deterministic analytics 120 for use in learning a pattern among the detected individuals/inputs. For example, one technique for enabling learning of a pattern may be found in http://support.sas.com/resources/papers/proceedings12/337-2012.pdf.

In one embodiment, as part of the analytics employed, at 350, the system may first determine whether the detected collaboration is a new collaboration, or at least deviates from an existing pattern by an amount exceeding a predetermined threshold. For example, the system may determine at 350 if the identified individuals corresponding to the received influencing inputs corresponds to a known group.

In one embodiment, the influencing inputs data may be received and processed at the decision engine 130 for individuals not identified with any existing group or pattern of activity, and thus indicating a possible new group forming. These scenarios indicate a deviation from a known collaborating group pattern exceeding a threshold deviation or the genesis of a new collaborative group/pattern.

If it is determined at 350 that the amount of the deviation from a pattern is below a certain threshold, e.g., is insubstantial, then the process returns to 320, FIG. 3A where methods at 320, and steps 330, 335 FIG. 3B are performed for those received influencing inputs. For example, this may occur for example, when the influencing events are received for the same group at the scheduled time and locations, however one or more and/or different resources are being used by the members than as the prior meeting before.

Otherwise, if it is determined at 350 that the detected collaboration appears as a deviation from an existing pattern exceeding above a certain threshold, e.g., more substantial deviation, the process continues to step 355. In one embodiment, for example, determining a deviation above a threshold may occur when the received inputs involve a sub-set of same individuals of an established group however does not match exactly, e.g., there is one or more fewer individuals detected from, or one or more new added individuals to a recurring group pattern; and/or it is determined that the received inputs match individuals of a known group, however are at an un-scheduled or unexpected time and/or location. In other non-liming examples, an additional types of pattern deviation that may be evaluated at above a deviation threshold might include a new meeting instance with a subject/title that has not been used before; an invite list that does not share much commonality with existing groups that have met before, a new meeting room AND a new call-in number AND a new online collaboration wiki link. Multiple changes would indicate that this is not a single change, but something different.

In such an instance of determining at 350 a new pattern forming (e.g., or a more substantial deviation from an existing pattern), the method proceeds to 355, FIG. 3A in which methods are invoked to make a further determination as to whether there is a need to send out a user questionnaire to an identified individual(s) of the group in order to obtain further feedback input which can be used by the analytics to determine whether this collaborating group pattern exists, or whether a new group or pattern has formed (or reduce the amount of deviation).

If, at 355, FIG. 3A there is no need determined to receive further information such as user feedback, e.g., as in the case of receiving inputs identifying a new group of collaborators, then the process proceeds to 385, FIG. 3B, where methods are invoked to establish and record data of the new collaboration group pattern, including identifying the new individuals; and recording the on-line or network-based resources used by those individuals at this new detected collaboration. The process may then return to step 305, FIG. 3A to repeat method 300. In this manner, the logic of method 300 may be repeated to detect group collaboration patterns that may be detected by the analytics employed at decision engine 130.

If, at 355 there is determined a need to receive further user feedback, in order to aid in detecting whether the current inputs relate to an existing pattern or group, the system at 365, FIG. 3A may automatically generate a question(s) to obtain from one or more identified individuals additional information that could be used in determining, by the decision engine logic, whether any other additional information can be added to lower the deviation to within the acceptable threshold. A non-limiting example question that may be asked is: “Are you in a meeting that is a continuation of “Hybrid Cloud Analytics Discussion” from Monday with individual X and individual Y?” or “Would you like to make resources for the “Hybrid Cloud Analytics Discussion” meeting available to individual U and individual Z now?”[

The process then continues at 370, FIG. 3B where the decision engine receives and process answers to better determine whether the deviation has been lowered to within the acceptable threshold of deviation of an existing group. Then, at 375, a determination is made as to whether, based on the received influencing inputs and the obtained additional information from the identified individuals, whether the amount of deviation has been lowered to the extent that becomes insubstantial, i.e., becomes below the threshold for matching with an existing group or based on a known pattern. If the deviation has been decreased below the threshold, then the process continues to step 320, FIG. 3A so that it could identify, obtain and present to the individuals the resources for use by that group.

However, if at 375, it is determined that the deviation remains above the threshold in which the additional information from the individuals did not really aid in lower the deviation from the acceptable threshold, then the process proceeds to 385, FIG. 3B, where methods are invoked to establish and record data of the new collaboration group pattern, including identifying the new individuals; and recording the on-line or network-based resources used/shared by those individuals at this new detected collaboration.

The process may then return to step 305, FIG. 3A in order to wait/process the next influencing inputs data. In this manner, over time, method 300 may be repeated to detect group collaboration patterns by the analytics employed at decision engine 130.

A first example utilizing tool 110 illustrates a process of a repeating meeting becoming established: 1) John schedules a meeting with a newly-formed research team, which consists of him, Karen, Pete, and Louise; 2) Since this is a new grouping of people, without any previous history, there is no immediate benefit provided by the system, but the people involved, location used, and any phone/web conferencing resources used; 3) The meeting goes on as per usual. The team uses several online resources to update a presentation file and spreadsheet; 4) As the meeting concludes, the system notes what electronic resources were used; 5) As the group continues to meet, those electronic resources become readily available at the beginning of the collaboration. For example, in John's browser, there is an option to fast-launch with several pages pre-loaded. Karen's iPad has a page that is pre-populated with apps that she used last time the group met so she doesn't have to go digging through folders to find them; 6) The longer the meetings continue, the stronger the patterns become established, and the easier it becomes to notice and detect new additions and deviations.

A second example utilizing tool 110 illustrates a process of adding a new team member dynamically: 1) The same team as above schedules a meeting; 2) Team members including team lead enter the room with an extra 5th person, John Doe (e.g., John Doe is there permanently and has been added to the group); 3) Team lead is prompted by a program via a user interface of that team leader's associated device: “Add John Doe to this collaboration?” with the options: Yes, No or Temporary Only; 4) Team lead clicks “yes”; 5) All appropriate electronic resources are now readily available from John Doe's electronic devices, and will become readily available the next time this team meets.

This meeting of five members may be scheduled periodically. However, an example deviation might be that one day, only four members show up. In one embodiment, this would not be enough to remove the person from the group nor to change the overall definition of that group, but after the third time, or if that person stops accessing those files, a change could be triggered.

A third example utilizing tool 110 illustrates a process of adding a team member temporarily: 1) Team lead schedules meeting with team; 2) four team members including team lead enter the room with an extra 5th person (John Doe) (e.g., John Doe is there temporarily for this one meeting); 3) Team lead is prompted by program “Add John Doe to this collaboration?”with the options Yes, No or Temporary Only; 4) Team lead clicks “no”; 5) All appropriate electronic resources are now readily available from John Doe's electronic devices; 6) When the meeting is done and John Doe leaves the room, quick links to files, applications and resources disappear. That is, in one embodiment, users may want resources to be made available a certain amount of time before a meeting, while others may want to review resources after a meeting.

In one embodiment, the learning “algorithm” employed may be an extension of the failure and success of past guesses. For example, if a team of 7 members meets every Monday in a particular room, and the system knows that because there is 1) a repeating calendar entry; and 2) all 7 people are connected to the same wireless access point; and 3) they all just badged in to the same building.

The user's use of the suggested resources, in addition to providing negative feedback (e.g., “no, that person is not joining this meeting, they just stopped by for something else”) will provides further input to the system where it can improve future guesses. This may include raising or lowering thresholds for matches, and broadening or tightening search criteria for finding relevant resources. Here, basic functionality of cognitive learning may be used, where, for example, a system learns over time to find what data is most important for what influences certain facts and trends.

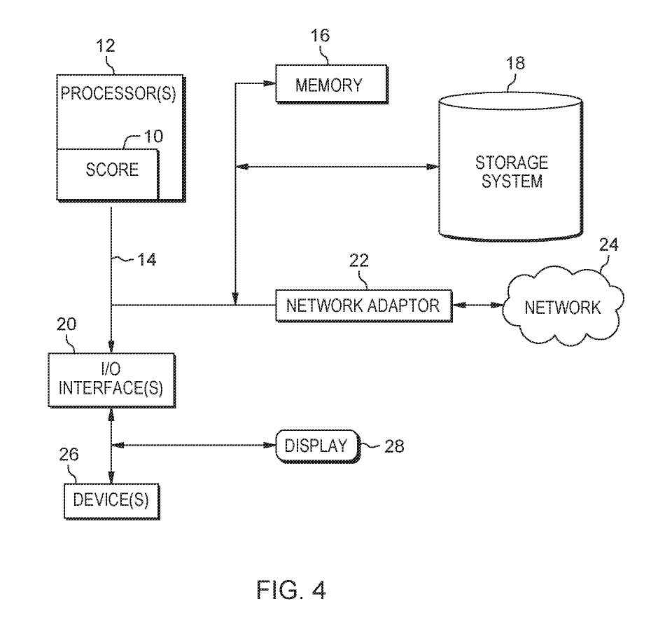

FIG. 4 illustrates a schematic of an example computer or processing system that may implement the resource-recall system under a collaborative environment for one regularly occurring meeting which approach is based on meeting logistics and the input of facilities (badge readers, telephone conferences, etc) in the embodiments of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 4 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. A resource-recall and decision engine module 10 having instructions employing the methods herein may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, and external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A resource-recall system under a collaborative environment comprising:
a memory storage device;
a processor unit in communication with said memory storage device and configured to
receive data representing events associated with individuals at a particular time and location;
track repeated instances of events involving said individuals;
track resources accessed by or shared with the individuals in association with one or more said repeated tracked events involving said individuals;
determine a group collaboration of said individuals based on said event tracking and resource sharing,
receive data indicating a subsequent event planned for said one or more said group of individuals; and
at the subsequent event involving one or more said group of individuals, automatically providing or enabling access to resources for members of the identified collaborative group based on said tracked resources

2. The system as claimed in claim 1, wherein to determine a group collaboration of said individuals based on said event, said processor unit is further configured to: implement non-deterministic analysis employing algorithms to detect patterns of collaborations of users and identify users of a group or collaboration based on the received events data.

3. The system as claimed in claim 2, wherein to determine a group collaboration of said individuals, said processor is further configured to:
use said non-deterministic techniques to determine based on said received inputs a deviation from an existing group or pattern; and
compare an amount of deviation against a threshold deviation,
and based on said comparing, one of:
identify and obtain said resources for provisioning to said individual members, or
record identified individuals as a new group or pattern in a memory storage means.

4. The system as claimed in claim 3, wherein to determine a group collaboration of said individuals, said processor device is further configured to:
based on said comparing, when determining said amount of deviation is above a threshold, record said identified individuals as a new group or pattern.

5. The system as claimed in claim 3, wherein to determine a group collaboration of said individuals, said processor device is further configured to:
based on said comparing, when determining said amount of deviation is above a threshold, further determine a need for further feedback from identified individuals of said group, and:
generate a questionnaire and communicate said questionnaire to one or more members for further information regarding a current collaboration; and
adjust an amount of deviation from said existing group or pattern based on said feedback information received from said one or more members responsive to said questionnaire.

6. The system as claimed in claim 5, wherein said processor device is further configured to:
determine that said adjusted amount of deviation from an existing group pattern is reduced below the threshold, and, in response,
identify and obtain said resources for provisioning to said individual members.

7. The system as claimed in claim 1, further comprising:
one or more of: a telephone conferencing system, web-conferencing system or e-mail system, wherein to receive data representing events associated with individuals at a particular time and location comprises:
receive in real-time input information from one or more of: said telephone conferencing system, web-conferencing system or e-mail system indicating a meeting is taking place at said time.

8. The system as claimed in claim 7, wherein to receive data indicating a subsequent event planned for said one or more said group of individuals comprises:
receive input information event from a respective individual's appointment calendar maintained by said scheduler in one or more said telephone conferencing, web-conferencing and e-mail systems,
said input information representing schedules meetings associated with individuals provided via said maintained appointment calendars maintained for each respective individual.

9. The system as claimed in claim 1, wherein to receive data representing events associated with individuals at a particular time and location, said processor device is configured to:
receive input information from a radio frequency identifier (RFID) sensor device;
detect identities of individuals based on receiving RFID signals received from the individuals occurring at a particular physical location within a time window.

10. A computer program product for providing resources to a group of collaborators processing customer orders for items, the computer program product comprising a computer usable medium having computer readable instructions embodied in said medium, said instruction configuring a computer to run a method comprising:
receiving data representing events associated with individuals at a particular time and location;
tracking repeated instances of events involving said individuals;
tracking resources accessed by or shared with the individuals in association with one or more said repeated tracked events involving said individuals;
determining a group collaboration of said individuals based on said event tracking and resource sharing,
receiving data indicating a subsequent event planned for said one or more said group of individuals; and
at the subsequent event involving one or more said group of individuals, automatically providing or enabling access to resources for members of the identified collaborative group based on said tracked resources.

11. The computer program product as claimed in claim 10, wherein said determining a group collaboration of said individuals based on said event comprises: implementing non-deterministic analysis employing algorithms to detect patterns of collaborations of said individuals and identify individuals of a group or collaboration based on the received events data.
